(19) United States
(12) Patent Application Publication
(10) Pub. No.: US 2007/0190234 A1
(43) Pub. Date: Aug. 16, 2007

(54) Common shadow mask for OLED lighting display

(75) Inventors: Todd R. Griffin, Webster, NY (US); Thomas W. Palone, Rochester, NY (US); David R. Strip, Albuquerque, NM (US); Yuan-Sheng Tyan, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/355,039

(22) Filed: Feb. 15, 2006

(51) Int. Cl. B05D 5/06; B05D 1/32

(52) U.S. Cl. 427/64; 427/282

(57) ABSTRACT

A method of making a display having a plurality of spaced apart organic light-emitting diodes devices (OLEDs) that have serially connected electrodes for providing a lighting display wherein each one of the OLED devices is spaced apart from the next OLED device.

### FIELD OF INVENTION

The present invention relates to an OLED light display having a plurality of spaced apart OLED devices that have serially connected electrodes and, more particularly, relates to an improved way for using a common shadow mask in making such light display.

### BACKGROUND OF THE INVENTION

Solid state lamps have the potential to provide lighting with significantly higher efficiency than current technologies. This potential has led to a wave of developments in the LED and OLED fields, increasing the basic device efficiencies. In addition, a number of device architectures are aimed at producing devices that are well suited to lighting applications. U.S. Pat. No. 6,693,296 discloses a solution to a number of challenges inherent in making an efficient, large area OLED lamp. This solution uses a monolithic serial structure to connect a number of OLED devices in series, which produces a lamp, that is directly compatible with common supply voltages and operates at lower current densities than individual devices.

Small molecule OLEDs (SMOLEDs), which are the most mature OLED technology, are produced via a vapor deposition process. For device layers which require patterns, a shadow mask is interposed between the evaporation source and the device. Typically each layer of the device requires a new shadow mask. The shadow masks are expensive to produce. In addition, because the masks are subject to error within a tolerance limit, the device design is constrained to dimensions which insure functionality in spite of these errors. In addition, each mask should be aligned with the substrate, a process that is also subject to errors. The device design should assure functionality in the face of these errors. In U.S. Pat. No. 6,693,296, an immediate consequence of compensating for these tolerances is that the spaces between light-emitting elements is increased. U.S. Pat. No. 5,742,129 discloses a method for the fabrication of multicolor, pixelated OLED devices in which the same mask is used to form the different colored pixels. However, the method taught in U.S. Pat. No. 5,742,129 requires the construction of “ramparts” on the substrate as well as different masks for the anode and cathode layers. U.S. Pat. No. 6,214,631 also teaches the construction of multicolored pixels in the form of a stacked OLED or “SOLED”. This method requires the fabrication of standoffs on the substrate to support the mask. Additionally, the method taught requires either than an electrostatic force be applied to the mask and OLED in order to either move the mask, in which case repulsive charges are applied, or to bring the mask into contact with the substrate, in which case attractive charges are applied. Alternatively, a lubricant can be applied to the standoffs to facilitate movement. OLEDs are well known for their high sensitivity to any contamination or variation in processing. The addition of the lubricant risks contamination of not only the device, but also the deposition chamber. The electrostatic charging of the substrate and mask risks changes in the surface morphology of the deposited layers.

A highly effective OLED lighting display, including a plurality of OLED devices, is set forth in commonly assigned U.S. Pat. No. 6,693,296. In this patent, the object was to provide an improved large area OLED display with reduced detrimental impacts due to series resistance and shorting defects. This arrangement is highly effective in producing light, but requires a number of shadow masks.

### SUMMARY OF THE INVENTION

It is an object of the present invention to provide a reduced number of shadow masks in making a lighting display having a plurality OLEDs wherein there is a serial connection between adjacent electrodes of OLEDs.

This object is achieved by a method of making a display having a plurality of spaced apart organic light-emitting diodes devices (OLEDs) that have serially connected electrodes for providing a lighting display wherein each one of the OLED devices is spaced apart from the next OLED device and includes first and second electrodes and an OLED unit having a plurality of organic layers disposed between the first and second electrodes, the method including:

a) providing a common shadow mask having a plurality of mask apertures;

b) depositing conductive material through the plurality of first mask apertures to form the first electrodes;

c) providing relative movement in one direction between the common shadow mask and the substrate to deposit through the first mask apertures one or more organic layers over the first electrodes of each OLED, while masking regions between adjacent OLEDs for electrical connection between electrodes; and

d) providing a second mask having a plurality of second mask apertures and depositing conductive material through the second mask to form the second electrodes over organic layers and in the mask region between OLEDs so that the second electrodes are in electrical contact with the first electrodes of the adjacent OLEDs.

### ADVANTAGES

The common shadow mask for OLED deposition of the present invention has the advantage of reducing the number of distinct masks required in the making of the OLED light display.

Another advantage is that it reduces the OLED sensitivity to tolerances in mask fabrication, permitting lower fabrication costs and improved devices through reduced device spacing and reduced dark bands.

A further advantage is that it reduces the cost of mask placement and alignment equipment to achieve the same or better accuracy than existing techniques.

### BRIEF DESCRIPTION OF THE DRAWINGS

FIG. 1 is a prior art cross-sectional view of the monolithic series connected OLED in a lighting display;

FIG. 2 is a prior art cross-sectional view of the monolithic series connected stacked OLED device;

FIG. 3 illustrates a shadow mask;

FIG. 4 illustrates a plan view of a first OLED layer configuration;

FIG. 5 illustrates a plan view of a second OLED layer configuration;

FIG. 6 illustrates a plan view of a third OLED layer configuration;

FIG. 7 illustrates a shadow mask for use with an alternative embodiment of the invention; and

FIG. 8 is a cutaway view of an alternative embodiment of the invention.

### DETAILED DESCRIPTION OF THE INVENTION

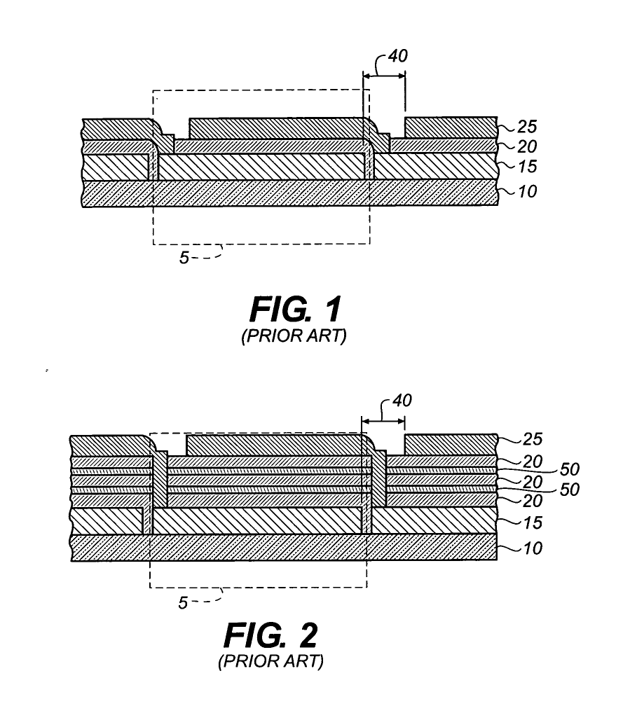

U.S. Pat. No. 6,693,296 discloses a design for a monolithic series-connected display having a plurality of OLEDs to provide a lighting source in which two or more individual OLED devices are connected in series. FIG. 1 is a cross sectional view of U.S. Pat. No. 6,693,296 prior art device. The OLED device 5 is produced by sequentially depositing an anode 15, a series of organic layers 20, and a cathode 25 on a substrate 10. In this device arrangement, as well as in all device arrangement discussed in this invention, anode 15 and cathode 25 can be made of an identical conductive material or can be different conductive materials such as those discussed in U.S. Pat. No. 6,693,296. As can be seen from FIG. 1, each OLED device 5 is serially connected to the device to its left and right by electrical contact between the anode of one device and the cathode of the device to its left. A dark gap 40 appears between consecutive devices. In many, if not most applications, this dark gap is an undesirable feature and is made as narrow as possible.

FIG. 2 is a cross sectional view of the prior art U.S. Pat. No. 6,693,296 device in a stacked configuration. The OLED device 5 is produced by sequentially depositing an anode 15, a series of organic layers 20, and an intermediate electrode 50 on substrate 10. Organic layers 20 and intermediate electrodes 50 are sequentially deposited on top of each other a number of times to form a stacked cell structure. Cathode 25 is deposited as the final layer on top of the last organic layers 20. As can be seen from this figure, each OLED device 5 is serially connected to the device to its left and right by contacts between the anode of one device and the cathode of the device to its left. A dark gap 40 appears between consecutive devices. In many, if not most applications, this dark gap is an undesirable feature and is made as narrow as possible.

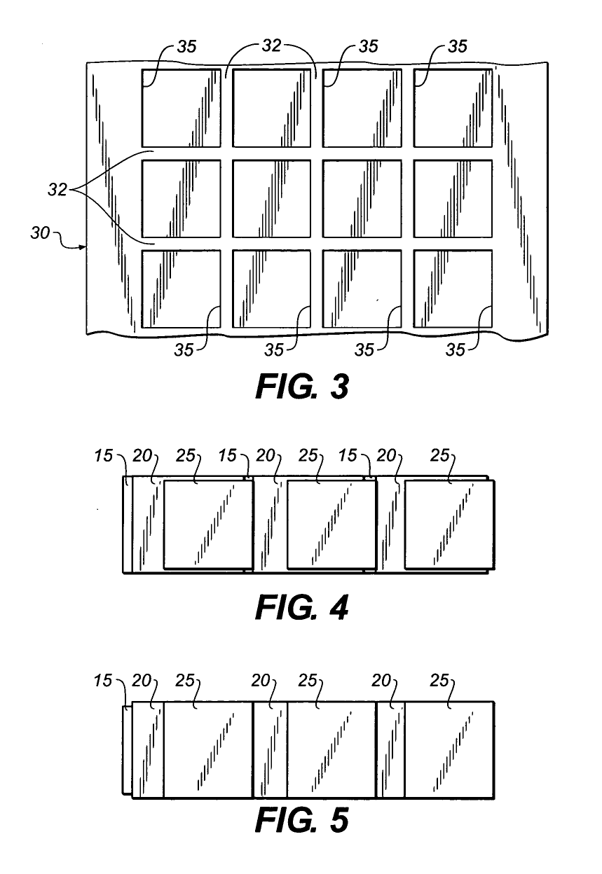

FIG. 3 shows a shadow mask 30 having a plurality of mask apertures 35 which can be used in accordance with the present invention. The size of the mask band 32, the tolerance in the size of the mask apertures 35, and the tolerance in placing the mask on the substrate in the deposition process determine how small the dark gap 40 can be made using traditional shadow masking techniques. In a typical use of the design disclosed in U.S. Pat. No. 6,693,296, the individual OLEDs, often referred to as pixels, are rectangular in shape (top view) and are electrically connected to form rows of devices. Multiple rows are formed on a common substrate, where the rows are connected in parallel to form a single device.

FIG. 4 is a plan view of a first configuration of the device shown in FIG. 1. In this configuration, anode 15 and organic layers 20 have identical footprints. Anode 15 and organic layers 20 can therefore be deposited using the same shadow mask and are spaced apart by shifting the mask in a single direction.

Cathode 25 is deposited with a separate shadow mask having a smaller footprint to insure that the cathode 25 is always contained within the bounds of organic layers 20, thus preventing shorting between the anode 15 and cathode 25.

Cathode 25 is deposited in a position on top of organic layers 20 such that a portion of the cathode layer 25 is deposited upon the exposed anode 15 of the adjacent OLED device, thus creating a serial connection between adjacent OLED devices.

FIG. 5 is a plan view of a second configuration of the device shown in FIG. 1 in accordance with the present invention. In this configuration, organic layers 20 and cathode 25 have identical footprints. Organic layers 20 and cathode 25 can therefore be deposited using the same shadow mask and are spaced apart by shifting the mask in a single direction. Anode 15 is deposited with a separate shadow mask having a smaller footprint to insure that the organic layers 20 overlap both horizontal edges and one vertical edge of the anode 15 to prevent shorting between the anode 15 and cathode 25. Cathode 25 is deposited in a position on top of organic layers 20 such that a portion of the cathode layer 25 is deposited upon the exposed anode 15 of the adjacent OLED device, thus creating a serial connection between adjacent OLED devices.

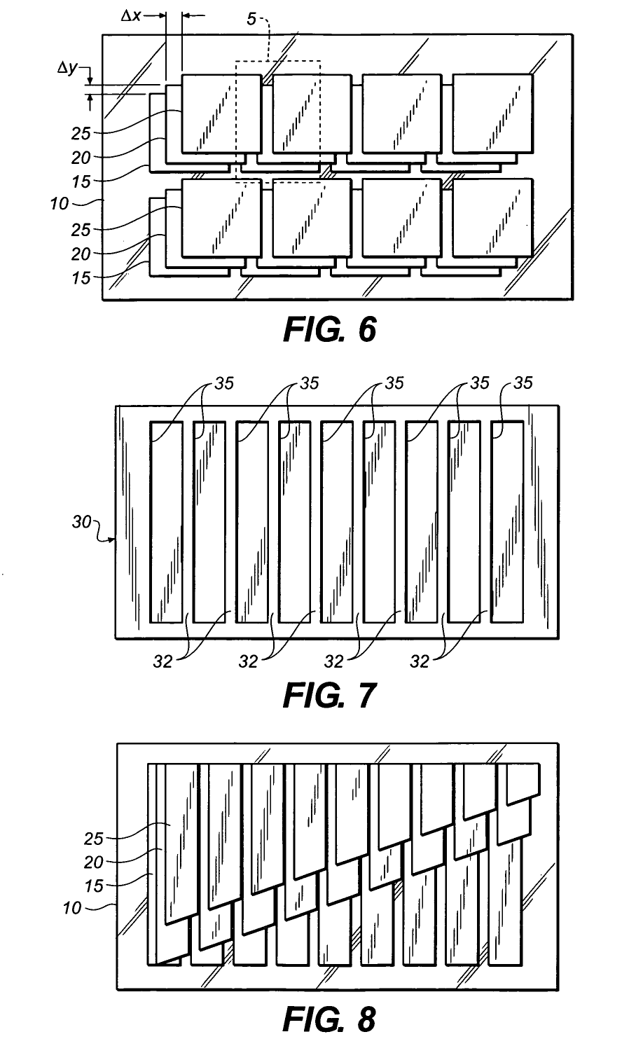

FIG. 6 shows a third and preferred embodiment of the invention. The anode 15, organic layers 20, and the cathode 25 of an individual OLED device 5 have identical shapes, which permits them to be deposited by a common shadow mask. The offset in the first direction, labeled Δx is required to create a serial connection of anode 15 of one OLED device with cathode 25 of the adjacent OLED device. The offset Δx is approximately equal to the width the mask band 32. Although other values will produce functional devices, this selection is preferable in many respects. Larger values will result in larger dark gaps 40, although smaller values will reduce the overlap between the cathode of one device and the anode of the next. Since this overlap contributes to the dark gap, it can be preferable to reduce this overlap as long as adequate contact area is maintained, including uncertainties in mask placement. The offset in a second direction, labeled Ay in the figure, is required to ensure shorting does not occur between anode 15 and the cathode 25 of the same OLED device. The offset Ay is approximately equal to the maximum positioning error in the mechanism that shifts the mask. Any smaller value risks a short between the anode and cathode of an individual device. Note that the row-to-row spacing is larger than the sum of the Ay steps. This is essential to prevent the cathode in one row from shorting across two anodes in the row above.

Several advantages accrue from the repeated use of a single mask. First, only one mask has to be designed and only a single set of tooling has to be produced. Inventory management of masks is simplified. These factors all contribute to lower cost. Because the same physical copy of the mask is used in all steps of the making of the OLED device, the process does not have to account for mask-to-mask variations in the size and location of the mask apertures. By limiting this factor from the tolerance stackup, masks can be made using a lower tolerance process, reducing cost, while still reducing the dark gap between pixels. The dark gap is an undesirable feature and any reduction in size is considered advantageous. The single mask system of the invention limits the need for precision mask placement for the step involving the common mask. Once the initial mask placement is established, the subsequent positions can be achieved using comparatively inexpensive actuators capable of providing small and highly accurate steps.

FIG. 7 shows a shadow mask for an alternative embodiment of the invention. The device is initially fabricated to contain a single row of tall, series connected pixels. The pixel-to-pixel structure is the same as that shown in FIG. 1, but with only a single row. The resulting device is shown in a cutaway view in FIG. 8. By shifting the common mask in one direction, any one of the structures shown in FIG. 4 or 5 can be produced. By shifting a single mask in two directions relative to each other, the structure shown in FIG. 6 can be produced. This embodiment has an advantage of producing long stripes of OLED devices which have reduced total area of dark gaps 40. It has the disadvantage that in the event of a short within the long row of the OLED device, the area of non-emitting light due to the short is much greater than in smaller discrete pixels. It also has the disadvantage in that a separate laser or mechanical scribing step is required to divide the columns into multiple rows if separation if desired.

An OLED device fabricated according to this invention will require additional steps in order to be useful. For example, the device will need to be encapsulated and the series-connected OLED devices need to be connected to leads or traces that will be available for external connection. These leads or traces can be fabricated by a number of ways familiar to those of ordinary skill in the art, such as patterning a highly conductive material from the externally accessible point to the exposed anodes and cathodes of the series OLEDs. The use of a common shadow mask for multiple layer deposition as described in this invention in no way interferes with using well known and established techniques for preparing and finishing the device in the steps not performed by the invention.

The invention has been described in detail with particular reference to certain preferred embodiments thereof, but it will be understood that variations and modifications can be effected within the spirit and scope of the invention.

### Parts List

5 OLED device
10 substrate
15 anode
20 organic layers
25 cathode
30 shadow mask
32 mask band
35 mask aperture
40 dark gap
50 intermediate electrode

1. A method of making a display having a plurality of spaced apart organic light-emitting diodes devices (OLEDs) that have serially connected electrodes for providing a lighting display wherein each one of the OLED devices is spaced apart from the next OLED device and includes first and second electrodes and an OLED unit having a plurality of organic layers disposed between the first and second electrodes, the method including:
a) providing a common shadow mask having a plurality of mask apertures;
b) depositing conductive material through the plurality of first mask apertures to form the first electrodes;
c) providing relative movement in one direction between the common shadow mask and the substrate to deposit through the first mask apertures one or more organic layers over the first electrodes of each OLED, while masking regions between adjacent OLEDs for electrical connection between electrodes; and
d) providing a second mask having a plurality of second mask apertures and depositing conductive material through the second mask to form the second electrodes over organic layers and in the mask region between OLEDs so that the second electrodes are in electrical contact with the first electrodes of the adjacent OLEDs.

2. The method according to claim 1 wherein, for each OLED device, the organic layers have a greater footprint than either the first or second electrodes.

3. A method of making a display having a plurality of spaced apart organic light-emitting diodes devices (OLEDs) that have serially connected electrodes for providing a lighting display wherein each one of the OLED devices is spaced apart from the next OLED device and includes first and second electrodes and an OLED unit having a plurality of organic layers disposed between the first and second electrodes, the method including:
a) providing a plurality of spaced apart first electrodes which correspond to each OLED device;
b) providing a common shadow mask having a plurality of mask apertures;
c) depositing through the first mask apertures one or more organic layers on the first electrode of each OLED, while masking regions between adjacent OLEDs for electrical connection between electrodes; and
c) providing relative movement in one direction between the common shadow mask and the substrate and then depositing conductive material through the first mask apertures to form the second electrode over the organic layers and in the mask region between the OLEDs so that the second electrode over the organic layers are in electrical contact with the first electrodes of the adjacent OLEDs.

4. A method of making a display having a plurality of spaced apart organic light-emitting diodes devices (OLEDs) that have serially connected electrodes for providing a lighting display wherein each one of the OLED devices is spaced apart from the next OLED device and includes first and second electrodes and an OLED unit having a plurality of organic layers disposed between the first and second electrodes, the method including:
a) providing a common shadow mask having a plurality of mask apertures;
b) depositing conductive material through the plurality of first mask apertures to form the first electrode;
c) providing relative movement in two directions between the common shadow mask and the substrate and then depositing through the first mask apertures one or more organic layers on the first electrode of each OLED, while masking regions between adjacent OLEDs for electrical connection between electrodes; and
d) providing relative movement in the same two directions between the common shadow mask and the substrate and then depositing conductive material through the first mask apertures to form the second electrodes on organic layers and in the mask region between OLEDs so that the second electrodes are in electrical contact with the first electrodes of the adjacent OLEDs.

5. The method according to claim 4 wherein, for each OLED device, the organic layers have the same footprint as both first or second electrodes.
